(19) United States
(12) Patent Application Publication
(10) Pub. No.: US 2020/0281197 A1
(43) Pub. Date: Sep. 10, 2020

(54) ACETIC ACID-BASED HERBICIDE COMPOSITION

(71) Applicant: Hippocratic Oligo Medicine Corporation Pty Ltd, City Beach, Western Australia (AU)

(72) Inventor: William Ernest Briggs, Coramba (AU)

(21) Appl. No.: 16/644,707

(22) PCT Filed: Sep. 21, 2018
(86) PCT No.: PCT/AU2018/051032

§ 371 Date: Mar. 5, 2020

(30) Foreign Application Priority Data
Sep. 21, 2017 (AU) 2017903835
Mar. 20, 2018 (AU) 2018900913
Aug. 10, 2018 (AU) 2018902926

(51) Int. Cl. A01N 37/02; A01N 33/12; A01N 25/02; A01N 59/20; A01N 65/28; A01N 65/06

(52) U.S. Cl. CPC A01N 37/02; A01N 33/12; A01N 65/06; A01N 59/20; A01N 65/28; A01N 25/02

(57) ABSTRACT

A herbicide composition includes water, hydrochloric acid, acetic acid, one or both of citric acid and a citrate salt, and at least two metal salts, wherein at least one of the metal salts is a transition metal salt and the at least two metal salts are independently present in an amount of at least 0.005 wt %.

### FIELD OF THE INVENTION

The present invention relates in general to the field of horticulture, agriculture and the control of undesirable plant growth. In particular, the invention relates to an acetic acid-based herbicide composition, a method of preparing the same, and the use and application thereof to kill a plant or retard its growth.

### BACKGROUND OF THE INVENTION

The use of herbicides to control undesirable plant growth is common place both in domestic horticulture and commercial agriculture. Herbicides are also commonly used to control undesirable plant growth around infrastructure such as public amenities.

Whilst being beneficial, if not essential, in modern day horticulture/agriculture and infrastructure maintenance, a major drawback of many herbicides currently used is that they are toxic to humans, animals and the environment in general.

Glyphosate (N-(phosphonomethyl)glycine) is a widely used broad-spectrum systemic herbicide and plant desiccant. Despite being an effective herbicide, extensive use of it has given rise to glyphosate tolerance in the field. Furthermore, there is mounting evidence to suggest its use is having a deleterious effect on the environment. There is now a growing movement across the world to ban the use glyphosate-based herbicide compositions.

Alternative and less toxic herbicide compositions are known. For example, aqueous solutions of acetic acid have been shown to exhibit herbicidal activity. However, conventional acetic acid-based herbicide compositions typically require a high concentration (e.g. of at least 20% v/v) of acetic acid to promote herbicidal activity, and even then their herbicidal activity is rather poor relative to other conventional herbicides.

Accordingly, there remains a need to develop herbicide compositions that are not only cost effective and perform well to control undesirable plant growth, but also pose reduced risk to the environment.

### SUMMARY OF THE INVENTION

The present invention provides a herbicide composition comprising water, hydrochloric acid, acetic acid, one or both of citric acid and a citrate salt, and at least two metal salts, wherein at least one of the metal salts is a transition metal salt and the at least two metal salts are independently present in an amount of at least 0.005 wt %.

The present invention also provides a method of preparing a herbicide composition, the method comprising combining with water: hydrochloric acid, one or both of citric acid and a citrate salt, acetic acid, and at least two metal salts, wherein at least one of the metal salts is a transition metal salt and the at least two meal salts are combined with the water in independent amounts of at least 0.005 wt %.

The invention further provides a herbicide composition produced according to the method of the invention.

The present invention also provides a method of killing a plant or retarding its growth, the method comprising contacting the plant with a herbicide composition according to the invention.

The present invention further comprises a method of controlling plant growth at a locus, the method comprising applying to the locus a herbicide composition according to the invention.

According to the present invention there is also provided use of a herbicide composition according to the invention to kill a plant or retard its growth.

The present invention yet further provides use of a herbicide composition according to the invention to control plant growth at a locus.

In one embodiment, the herbicide composition further comprises an ammonium salt.

In a further embodiment, the herbicide composition comprises phosphoric acid.

In yet a further embodiment, the herbicide composition comprises sulphuric acid.

In one embodiment, the herbicide composition comprises both citric acid and a citrate salt.

In another embodiment, the at least two metal salts are both metal halide salts.

In yet a further embodiment, the herbicide composition comprises a surfactant.

In another embodiment, the herbicide composition comprises a hydrophobic liquid.

In a further embodiment, the herbicide composition comprises an aqueous freezing point depressant agent.

In still a further embodiment, the at least two metal salts comprise a deliquescent metal salt.

In one embodiment, the method of preparing a herbicide composition in accordance with the invention includes a first step comprising combining with water: hydrochloric acid, citric acid and one of the at least two metal salts; a second step comprising combining with the solution formed in step 1: the remaining metal salt(s) and sodium hypochlorite; and a third step comprising combining with the solution formed in step 2: acetic acid.

In one embodiment, the addition of sodium hypochlorite in step 2 of the method converts at least some of the citric acid to sodium citrate.

In another embodiment, the method of preparing a herbicide composition according to the invention further comprises combining with the water: an ammonium salt.

In a further embodiment, the method of preparing a herbicide composition in accordance with the invention further comprises combining with the water: phosphoric acid.

In yet a further embodiment, the method of preparing a herbicide composition in accordance with the invention further comprises combining with the water: sulfuric acid.

In another embodiment, the method of preparing a herbicide composition according to the invention further comprises combining with the water: a surfactant.

In yet another embodiment, the method of preparing a herbicide composition according to the invention further comprises combining with the water: a hydrophobic liquid.

In a further embodiment, the method of preparing a herbicide composition according to the invention further comprises combining with the water: an aqueous freezing point depressant agent.

When manufacturing the herbicide composition it may be convenient to first prepare a precursor herbicide composition and add to that composition acetic acid to form the herbicide composition.

The present invention therefore provides a precursor herbicide composition, the composition comprising water, hydrochloric acid, one or both of citric acid and a citrate salt, and at least two metal salts, wherein at least one of the metal salts is a transition metal salt and the at least two metal salts are independently present in an amount of at least 0.005 wt %.

Apart from acetic acid, other components to be included in the herbicide composition may be added to the precursor herbicide composition.

The present invention further provides a method of preparing a precursor herbicide composition, the method comprising combining with water: hydrochloric acid, one or both of citric acid and a citrate salt, and at least two metal salts, wherein at least one of the metal salts is a transition metal salt and the at least two meal salts are combined with the water in independent amounts of at least 0.005 wt %.

In one embodiment, the method of preparing a precursor herbicide composition includes a first step comprising combining with water: hydrochloric acid, citric acid and one of the at least two metal salts; and a second step comprising combining with the solution formed in step 1: the remaining metal salt(s) and sodium hypochlorite.

The present invention further provides a method of preparing a herbicide composition, the method comprising combining the precursor herbicide composition according to the invention with acetic acid.

The present invention also provides a herbicide composition comprising water, hydrochloric acid, acetic acid, one or both of citric acid and a citrate salt, and at least two metal salts, wherein at least one of the metal salts is a transition metal salt and the at least two metal salts are independently present in an amount of at least 0.005 wt %, the composition further comprising one or more products formed through reaction of sodium hypochlorite with one or more of the hydrochloric acid, the acetic acid, the citric acid and the at least two metal salts.

It has now been found that herbicide compositions according to the present invention surprisingly exhibit improved herbicidal activity relative to conventional acetic acid-based herbicide compositions. Furthermore, herbicide compositions in accordance with the invention can exhibit comparable herbicidal activity to many non-acetic acid-based herbicide compositions, such as those containing glufosinate-ammonium.

Notably, unlike conventional acetic acid-based herbicide compositions, those in accordance with the present invention can exhibit excellent herbicidal activity at acetic acid concentrations of less than 10 wt %, or even less than 5 wt % of acetic acid.

The herbicide compositions in accordance with the present invention also exhibit excellent herbicidal activity at high acetic acid concentrations.

Without wishing to be limited by theory, the excellent herbicidal activity of the composition in accordance with the invention is believed to result from the unique combination of the constituent components of the composition. The acetic acid component is believed to facilitate break-down of the waxy cutin coating on plants and also assist with desiccation of the plant. Break-down of the waxy cutin coating in turn facilitates systemic uptake of the citric acid and/or citrate salt and the at least two metal salts by the plant. The plant uptake of citric acid and/or citrate salt and the metal salts is believed to promote effective cell degradation of the plant, the net effect of which retards growth of the plant or kills the plant. When present, the ammonium salt is believed to facilitate uptake of the herbicide composition by a plant to thereby provide a boost in its efficacy. Other constituent components present can assist with promoting wetting of the composition on a plant/locus, ensuring all components remain soluble in the composition and enhanced dehydration of the plant cells.

Also without wishing to be limited by theory, constituent components of the herbicide composition are believed to function synergistically to enable excellent herbicidal activity to be realised at low concentration, and in particular low concentration of acetic acid. Introducing constituent components such as an ammonium salt, phosphoric acid, hydrophobic liquid, surfactant, aqueous freezing point supressing agent, deliquescent metal salts and/or sulphuric acid into the herbicide composition has surprisingly and advantageously been found to further enhance the herbicidal activity of the composition.

The nature of the constituent components in the herbicide composition and their amount and concentration typically employed also renders the compositions relatively environmentally friendly.

### DETAILED DESCRIPTION OF THE INVENTION

The present invention provides a herbicide composition. As used herein the term “herbicide” is intended to mean a composition comprising one or more constituent components capable of killing a plant or retarding the plant's growth. Application of the herbicide will generally be employed for killing or retarding the growth of one or more undesirable plant species, for example one or more weeds. The expression “herbicidal activity” therefore refers to the potential of the composition to function as a herbicide.

The present invention also provides a precursor herbicide composition. The term “precursor” in that context is intended to mean that composition can be used to form the herbicide composition according to the invention by addition of acetic acid. It can be convenient to manufacture and transport the precursor herbicide composition and subsequently convert it into the herbicide composition at a destination closer to its intended application.

Herbicide compositions in accordance with the invention may be classified as a non-selective herbicide. In that context, the term “non-selective” refers to the spectrum of plant species against which the herbicide is active, with non-selective herbicides being active against most if not all plant species.

Common plant species to which the herbicide compositions according to the invention demonstrate herbicidal activity include, but are not limited to, hardwood plants such as blackberry and lantana and annual/perennial broad leaf plants such as common weeds and grasses.

Herbicide compositions in accordance with the invention are liquid-based and can be conveniently applied to a target plant(s) or locus using conventional liquid-based herbicide application means. Such application means include, but are not limited to spray, pour or rub application.

Herbicide compositions in accordance with the invention will generally be used as a post-emergent (i.e. application directly to a plant(s)) herbicide.

The herbicide composition according to the invention will typically be applied to make contact with at least some part of the plant structure situated above the ground. For example, the composition may be applied to the plant foliage and or stem structure.

The herbicide composition is used in an amount and at a concentration to achieve the desired herbicidal activity. The desired herbicidal activity may be to kill the plant or simply to retard its growth. If required, the desired herbicidal activity may be achieved through multiple applications of the herbicide composition to a plant(s) or locus.

As those skilled in the art will appreciate, the amount and concentration of the herbicide composition to be used in a given application will vary depending on a number of factors such as the plant species and the desired herbicidal activity outcome (i.e. to kill the plant or merely retard its growth). Having regard to the teaching herein, those skilled in the art will be able to readily select the amount and concentration of the herbicide composition to be used in a given application.

The herbicide composition in accordance with the invention can advantageously be provided in a variety of concentrate forms that can be used directly or diluted depending upon the intended application. For example, the concentrate form of the composition may be used on hard wood plants such as blackberry or lantana by poring it into root areas or application directly onto freshly cut stems, or the concentrate form may be diluted for use in spraying on broad leaf weeds or grasses.

Unless otherwise specified, as used herein the expression “wt %” is intended to mean the percentage by weight of the specified component relative to the total weight of all components present in the herbicide composition.

The herbicide or precursor herbicide composition in accordance with the invention comprises water. In one embodiment, the water is de-mineralised water.

The amount of water present will generally vary from about 2 wt % to about 98 wt %.

The less water the composition contains, the more concentrated it will be. The concentration of the composition will be tailored for a given application.

In one embodiment, water is present in the herbicide composition in an amount ranging from about 2 wt % to about 35 wt %, or form about 2 wt % to about 25 wt %, or form about 2 wt % to about 20 wt %, or from about 35 wt % to about 65 wt %, or from about 75 wt % to about 98 wt %.

The herbicide composition further comprises hydrochloric acid. The hydrochloric acid will typically be provided by way of using a concentrated aqueous hydrochloric acid solution (e.g. a 32 wt % aqueous hydrochloric acid solution).

The herbicide composition in accordance with the invention will generally comprise from about 0.0096 wt % to about 1.6 wt % hydrochloric acid, or form about 0.01 wt % to about 6 wt % hydrochloric acid.

The herbicide composition may also be expressed as generally comprising about 0.03 wt % to about 5 wt % of a 32 wt % aqueous hydrochloric acid solution, or form about 0.03 wt % to about 18 wt % of a 32 wt % aqueous hydrochloric acid solution.

In one embodiment, the herbicide composition comprises about 0.032 wt % to about 1.6 wt % hydrochloric acid, or from about 0.096 wt % to about 0.64 wt %, or from about 0.0096 wt % to about 0.16 wt %.

In further embodiment, the herbicide composition may comprise 32 wt % aqueous hydrochloric acid in an amount ranging from about 1 wt % to about 5 wt %, or from about 0.3 wt % to about 3 wt %, or from about 0.3 wt % to about 2 wt %, or from about 0.03 wt % to about 0.5 wt %, or from about 0.01 wt % to about 0.25 wt %.

The herbicide composition in accordance with the invention comprises one or both of citric acid and a citrate salt.

By a “citrate salt” is meant one, two or three carboxylic acid functional groups of citric acid are in the form of a carboxylate anion that is/are neutralised with a metal cation. Examples of suitable metal cations include, but are not limited to, sodium, potassium, magnesium, copper, calcium and combinations thereof.

In one embodiment, the citrate salt comprises one or more of a mono metal cation citrate salt, a bi-metal cation citrate salt and a tri-metal cation citrate salt.

In a further embodiment, the citrate salt comprises a mono metal cation citrate salt.

In a further embodiment, the citrate salt comprises mono sodium citrate.

When present, the citrate salt may be provided as a pre-formed citrate salt and combined with the other constituent components during manufacture of the composition. Alternatively, a citrate salt may be formed in situ during manufacture of the herbicide composition.

In one embodiment, the herbicide composition comprises both citric acid and a citrate salt.

When used, the citrate salt may be present in an amount ranging from about 3 wt % to about 35 wt %, or from about 5 wt % to about 35 wt %, or from about 3 wt % to about 30 wt %, or from about 5 wt % to about 30 wt %, or from about 10 wt % to about 25 wt %, or from about 15 wt % to about 25 wt %, based on the total amount of citric acid and citrate salt used in the composition.

The combined amount of the citric acid and citrate salt (when present) in the herbicide composition according to the invention will generally range from about 0.1 wt % to about 20 wt %, or from about 0.4 wt % to about 20 wt %.

In one embodiment, the combined amount of citric acid and citrate salt (when present) in the herbicide composition ranges from about 2 wt % to about 20 wt %, or from about 5 wt % to about 20 wt %, or from about 0.6 wt % to about 7 wt %, or from about 1 wt % to about 7 wt %, or from about 0.4 wt % to about 4 wt %, or from about 0.1 wt % to about 2 wt %.

The herbicide composition in accordance with the invention also comprises at least two metal salts, wherein at least one of the metal salts is a transition metal salt. For avoidance of any doubt, the at least two metal salts must have different metal cations. In other words, the compositions comprise at least two metal salts having different metal cations, wherein at least one of the metal salts is a transition metal salt.

There is no particular limitation on the type of transition metal of the transition metal salt that is to be employed. Generally the transition metal salt will have a transition metal selected from manganese, iron, nickel, copper and combinations thereof.

The at least two metal salts may be transition metal salts.

Where one of the at least two metal salts is not a transition metal salt, there is no particular limitation on the type of metal employed. Generally, a non-transition metal salt will have a metal component selected from lithium, sodium, potassium, magnesium, calcium, zinc, and combinations thereof.

In one embodiment, the at least two metal salts comprise a copper salt and a magnesium salt.

There is no particular limitation on the type of counter anion that may be associated with the metal cation of the metal salt.

In one embodiment, the at least two metal salts are selected from metal halide salts, metal sulphate salts, metal nitrate salts, metal phosphate salts and combinations thereof.

In one embodiment, at least one of the at least two metal halide salts is a metal halide salt.

Suitable metal halide salts include metal fluoride salts, metal chloride salts, metal bromide salts, metal iodide salts and metal astatine salts.

In one embodiment, at least one of the at least two metal salts is a metal chloride salt.

In another embodiment, at least two of the at least two metal salts are a metal chloride salts.

In one embodiment, the at least one metal salt that is a transition metal salt is selected from copper nitrate, copper chloride, copper sulphate and combinations thereof.

In a further embodiment, the at least two metal salts comprise magnesium chloride.

In a further embodiment, the at least two metal salts comprise sodium chloride.

In one embodiment, the at least two metal salts comprise a deliquescent metal salt. By a metal salt being “deliquescent” is meant the salt, upon being exposed to air, will absorb sufficient moisture from the air so as to form a solution. Examples of suitable deliquescent metal salts include ZnCl₂, CaCl₂, MgCl₂, and FeCl₃.

In one embodiment, the deliquescent metal salt is not a metal hydroxide.

In a further embodiment, the at least two metal salts comprise zinc chloride.

Without wishing to be limited by theory, it is believed the at least two metal salts, wherein at least one of the metal salts is a transition metal salt, play an important role in the achieving the advantageous herbicidal activity of the compositions. In particular, on application to a plant the different metal salts are believed to penetrate into its vascular system and promote electrolytic activity that disrupts the cell structure of the plant. That disrupted cell structure is in turn believed to enhance the flow of herbicidal components into the plant and release of water from the plant (i.e. desiccation or dehydration).

The at least two metal salts will therefore be present in the composition not as mere residues or at trace levels. According to the invention the at least two metal salts are independently present in an amount of at least 0.005 wt %, or at least 0.01 wt %, or at least 0.05 wt %, or at least 0.1 wt %, or at least 0.5 wt %, or at least 1 wt %, or at least 2 wt %.

Sea salt often contains trace levels of a variety of different metal salts. The at least two metal salts used in the present invitation are not intended to be derived from trace levels of such metals salts that could be introduced should sea salt be used in accordance with the invention. Furthermore, the use of sea salt in accordance with the invention has the potential to introduce a number of undesirable anionic species into the compositions.

Accordingly, in one embodiment, the compositions according to the invention do not contain sea salt.

In one embodiment, each of the at least two metal salts is present in the compositions in an amount of at least 0.005 wt %, or at least 0.01 wt %, or at least 0.05 wt %, or at least 0.1 wt %, or at least 0.5 wt %, or at least 1 wt %, or at least 2 wt %.

The at least one transition metal salt will typically be present in the composition, relative to the other metal salt, in a ratio of at least 1:2, for example in a ratio ranging from about 1:2 to about 1:20.

In one embodiment, the at least two metal salts are independently present in an amount ranging from about 0.005 wt % to about 60 wt %, or from about 0.005 wt % to about 40 wt %, or from about 0.005 wt % to about 20 wt %, or 0.005 wt % to about 15 wt %, or 0.005 wt % to about 10 wt %, or from about 0.005 wt % to about 5 wt %. The upper limit amount of a given metal salt used may depend on factors such as the intended application of the herbicide composition and the metal salt solubility in the herbicide composition.

In another embodiment, the at least two metal salts are independently present in an amount ranging from about 2 wt % to about 60 wt %, or from about 2 wt % to about 40 wt %, or from about 2 wt % to about 20 wt %, or from about 0.6 wt % to about 10 wt %, or from about 0.6 wt % to about 4 wt %, or from about 0.6 wt % to about 2 wt %, or from about 0.05 wt % to about 5 wt %, or from about 0.05 wt % to about 2 wt %.

In one embodiment, each of the at least two metal salts is independently present in an amount ranging from about 0.005 wt % to about 60 wt %, or from about 0.005 wt % to about 40 wt %, or from about 0.005 wt % to about 20 wt %, or 0.005 wt % to about 15 wt %, or 0.005 wt % to about 10 wt %, or from about 0.005 wt % to about 5 wt %. The upper limit amount of a given metal salt used may depend on factors such as the intended application of the herbicide composition and the metal salt solubility in the herbicide composition.

In another embodiment, each of the at least two metal salts is independently present in an amount ranging from about 2 wt % to about 60 wt %, or from about 2 wt % to about 40 wt %, or from about 2 wt % to about 20 wt %, or from about 0.6 wt % to about 10 wt %, or from about 0.6 wt % to about 4 wt %, or from about 0.6 wt % to about 2 wt %, or from about 0.005 wt % to about 5 wt %, or from about 0.005 wt % to about 2 wt %.

Where the herbicide composition comprises two or more transition metal salts, their combined mass in that composition may be present in an amount of at least 0.005 wt %.

Where the herbicide composition comprises two or more non-transition metal salts, their combined mass in that composition may be present in an amount of at least 0.005 wt %.

Where the herbicide composition comprises two or more transition metal salts, their combined mass in that composition may range from about 0.005 wt % to about 60 wt %, or form about 0.005 wt % to about 40 wt %, or from about 0.005 wt % to about 20 wt %, or from about 0.005 wt % to about 10 wt %.

In one embodiment, where the herbicide composition comprises two or more transition metal salts, their combined mass in that composition may range from about 2 wt % to about 60 wt %, or from about 2 wt % to about 40 wt %, or from about 2 wt % to about 20 wt %, or from about 2 wt % to about 10 wt %, or from about 0.6 wt % to about 10 wt %, or from about 0.6 wt % to about 4 wt %, or from about 0.005 wt % to about 5 wt %, or from about 0.005 wt % to about 2 wt %.

Where the herbicide composition comprises two or more non-transition metal salts, their combined mass in that composition may range from about 0.005 wt % to about 60 wt %, or from about 0.005 wt % to about 40 wt %, or from about 0.005 wt % to about 30 wt %, or from about 0.005 wt % to about 20 wt %, or from about 0.005 wt % to about 10 wt %.

In one embodiment, where the herbicide composition comprises two or more non-transition metal salts, their combined mass in that composition may range from about 10 wt % to about 60 wt %, or from 10 wt % to about 40 wt %, or form 10 wt % to about 30 wt %, or from 10 wt % to about 20 wt %, or from about 5 wt % to about 20 wt %, or from about 4 wt % to about 20 wt %, or from about 4 wt % to about 10 wt %, or from about 1 wt % to about 5 wt %, or from about 1 wt % to about 4 wt %, or from about 0.005 wt % to about 5 wt %, or from about 0.005 wt % to about 1 wt %.

Where the herbicide composition in accordance with the invention comprises one transition metal salt and one non-transition metal salt, each of the metal salts may each be independently present in an amount ranging from about 0.005 wt % to about 30 wt %, 0.005 wt % to about 20 wt % or about 0.005 wt % to about 10 wt %.

In one embodiment, where the herbicide composition comprises one transition metal salt and one non-transition metal salt, each of the metal salts may each be independently present in an amount ranging from about 2 wt % to about 30 wt %, or from about 2 wt % to about 20 wt %, or from about 2 wt % to about 10 wt %, or from about 0.6 wt % to about 10 wt %, or from about 0.6 wt % to about 4 wt %, or from about 0.005 wt % to about 5 wt %, or from about 0.005 wt % to about 2 wt %.

It will be appreciated that reference herein to the at least two metal salts being “independently” present in an amount of at least 0.005 wt % (or other wt. % values) is intended to be in the context of the respective transition and non-transition metal salt content. In other words, the compositions may comprise one or more transition metals salts with a combined mass of at least 0.005 wt % or one or more non-transition metals salts with a combined mass of at least 0.005 wt %. Where only one transition and non-transition metal salts are present, each salt will be present in an amount of at least 0.005 wt %.

In the ranges for the at least two metal salts defined herein, the lower limit in any given range may be substituted with any one of the following values: about 0.005 wt %, or about 0.01 wt %, or about 0.05 wt %, or about 0.1 wt %, or about 0.5 wt %, or about 1 wt %, or about 2 wt %.

Similarly, the lower limit of the at least two metal salts defined herein may be substituted with any one of the following values: at least 0.005 wt %, or at least 0.01 wt %, or at least 0.05 wt %, or at least 0.1 wt %, or at least 0.5 wt %, or at least 1 wt %, or at least 2 wt %.

The herbicide compositions in accordance with the invention also comprise acetic acid. The compositions can advantageously be manufactured using glacial acetic acid. For convenience, the amount of acetic acid present in the compositions may be defined herein in terms of its glacial acetic acid content. For avoidance of any doubt, where a wt % of acetic acid is mentioned herein, it is to be taken as the wt % of glacial acetic acid.

The herbicide compositions in accordance with the invention will generally comprise about 0.5 wt % to about 90 wt % acetic acid, or from about 1.5 wt % to about 90 wt % acetic acid.

In one embodiment, the herbicide compositions in accordance with the invention comprise about 10 wt % to about 90 wt % acetic acid, or from about 20 wt % to about 90 wt % acetic acid, or from about 30 wt % to about 90 wt % acetic acid, or from about 10 wt % to about 30 wt % acetic acid, or from about 10 wt % to about 20 wt % acetic acid, or from about 0.5 wt % to about 10 wt % acetic acid, or from about 0.5 wt % to about 5 wt % acetic acid, or from about 1.5 wt % to about 10 wt % acetic acid, or from about 1.5 wt % to about 5 wt % acetic acid.

Water soluble constituent components of herbicide compositions in accordance with the invention and their concentration will be typically selected to have solubility in the herbicide composition such that they remain in solution at temperatures at which application of the herbicide composition takes place. The herbicide composition will generally be applied at temperatures ranging from about 5° C. to about 45° C., or from about 10° C. to about 45° C., or from about 15° C. to about 45° C.

Where herbicide compositions in accordance with the invention are to be transported and/or used in environments that may promote freezing of the aqueous constituent component, it may be desirable to introduce in the composition an aqueous freezing point supressing agent. Such agents and their application concentration are known in the art.

In one embodiment, the herbicide compositions in accordance with the invention comprise an aqueous freezing point supressing agent.

Examples of aqueous freezing point supressing agents include C1-C6 mono-alcohols (e.g. methanol, ethanol, propanol, butanol, pentanol, hexanol (including all structural isomers thereof)), C2-C6 di-alcohols (e.g. ethylene glycol, propylene glycol, butylene glycol, pentylene glycol, hexylene glycol (including all structural isomers thereof)), C3-C6 tri-alcohols (e.g. propylene triol, butylene triol, pentylene triol, hexylene triol (including all structural isomers thereof)), and combinations thereof.

The herbicide compositions in accordance with the invention will generally comprise (when present) about 0.05 wt % to about 10 wt % aqueous freezing point supressing agent.

In one embodiment, the herbicide compositions in accordance with the invention may comprise about 0.05 wt % to about 3 wt % aqueous freezing point supressing agent, or about 3 wt % to about 6 wt % aqueous freezing point supressing agent, or from about 6 wt % to about 9 wt % aqueous freezing point supressing agent.

Use of an aqueous freezing point supressing agent in the herbicide compositions can enable use of the compositions in environments that would otherwise cause the compositions to freeze and become unusable.

In one embodiment, the aqueous freezing point supressing agent is selected from iso-propanol, glycerol and combinations thereof.

The herbicide composition in accordance with the invention may also comprise an ammonium salt.

There is no particular limitation on the type of ammonium salt that can be employed. Generally the ammonium salt will be selected from ammonium sulphate, ammonium nitrate, ammonium phosphate, and combinations thereof.

The herbicide compositions in accordance with the invention will generally comprise (when present) about 0.4 wt % to about 10 wt % ammonium salt.

In one embodiment, the herbicide compositions in accordance with the invention may comprise about 1 wt % to about 10 wt % ammonium salt, or about 0.6 wt % to about 5 wt % ammonium salt, or from about 0.4 wt % to about 2 wt % ammonium salt.

The herbicide composition in accordance with the invention may further comprise phosphoric acid.

The herbicide compositions in accordance with the invention will generally comprise (when present) about 0.4 wt % to about 10 wt % phosphoric acid.

In one embodiment, the herbicide compositions in accordance with the invention comprise about 1 wt % to about 10 wt % phosphoric acid, or about 0.6 wt % to about 5 wt % phosphoric acid, or from about 0.4 wt % to about 2 wt % phosphoric acid.

The herbicide compositions in accordance with the invention may also comprise sulfuric acid. The compositions can advantageously be manufactured using 98 wt % sulfuric acid (i.e. concentrated sulfuric acid). For avoidance of any doubt, where a wt % of sulfuric acid is mentioned herein, it is to be taken as a wt % of concentrated sulfuric acid.

The herbicide compositions in accordance with the invention will generally comprise (when present) about 0.025 wt % to about 25 wt % sulfuric acid.

In one embodiment, the herbicide compositions in accordance with the invention comprise about 0.05 wt % to about 25 wt % sulfuric acid, or from about 0.05 wt % to about 15 wt % sulfuric acid, or from about 0.05 wt % to about 10 wt % sulfuric acid, or from about 0.05 wt % to about 5 wt % sulfuric acid, or from about 0.1 wt % to about 5 wt % sulfuric acid, or from about 0.1 wt % to about 0.3 wt % sulfuric acid, or from about 0.025 wt % to about 2 wt % sulfuric acid, or from about 0.025 wt % to about 0.05 wt % sulfuric acid.

The herbicide compositions in accordance with the invention may also comprise a surfactant. The surfactant may be used to reduce the surface tension of the composition and thereby facilitate wetting of a surface on which the composition is applied. For example, use of the surfactant may facilitate wetting of a plant or locus on which the composition is applied. The surfactant may also be used to help emulsify water insoluble components within the composition (for example the hydrophobic liquid).

Reference to using a surfactant in the herbicide compositions according to the invention may therefore be in the context of functioning as a wetting agent, an emulsifying agent, or both.

Provided the surfactant does not adversely affect herbicidal activity of the composition and it reduces the surface tension of the composition and/or functions as an emulsifying agent, there is no particular limitation on the type of surfactant that may be used.

In one embodiment, the herbicidal composition comprises a surfactant, for example non-ionic surfactant. Examples of suitable non-ionic surfactants that may be used include, but are not limited to, alkyl polyglycoside surfactants, alkoxylated alcohols (such as ethoxylated alcohols, propoxylated alcohols and ethoxylated/propoxylated alcohols), mono glycerol fatty acid esters (e.g. mono glycerol C₈-C₂₀ fatty acid esters) and combinations thereof.

When used, a surfactant will generally be present in the herbicide composition in an amount ranging from about 0.0001 wt % to about 20 wt %. The amount used will generally depend on whether or not the composition is to be diluted before being used and/or the intended function of the surfactant (e.g. wetting agent and/or emulsifier). Those skilled in the art will be able to readily employ a suitable amount of surfactant as required.

In one embodiment, the herbicide compositions in accordance with the invention comprise surfactant in an amount of about 0.05 wt % to about 15 wt %, or from about 0.05 wt % to about 10 wt %, or from about 0.05 wt % to about 5 wt %, or from about 0.01 wt % to about 6 wt %, or from about 0.05 wt % to about 0.2 wt %, or from about 0.01 wt % to about 0.05 wt %, or from about 0.0001 wt % to about 0.3 wt %, or from about 0.0001 wt % to about 0.01 wt %, or from about 0.8 wt % to about 20 wt %, or from about 0.4 wt % to about 8 wt %, or from about 0.8 wt % to about 1.5 wt %, or about 0.4 wt % to about 0.8 wt %, or from about 0.01 wt % to about 0.4 wt %.

When used as an emulsifier, the surfactant may of course also function as a wetting agent. The amount of surfactant used to provide an emulsifying function will typically be more than that used to provide only a wetting agent function.

In another embodiment, the herbicide composition comprises a hydrophobic liquid.

By a “hydrophobic liquid” is intended to mean a substance that (i) is liquid at typical application temperatures of the herbicide composition, for example at least 5° C., or 10° C., or 15° C., or 20° C. or 25° C., and (ii) has little or no solubility in water.

When present, the hydrophobic liquid may be used in combination with a surfactant. In that case, the surfactant can assist with emulsification of the hydrophobic liquid within the herbicide composition.

Without wishing to be limited by theory, it is believed incorporating a hydrophobic liquid in the herbicide compositions can improve the efficacy of the composition. Upon applying the herbicide composition to a plant it is believed the hydrophobic liquid can develop a water barrier layer on the surface of plant that can at least (i) reduce loss of active agents from the plant under the action of rain, and (ii) improve the function of certain active agents in the composition. With regard to (ii), where the composition comprises a deliquescent metal salt, the hydrophobic liquid barrier on the surface of plant can facilitate moisture within the plant being drawn to and bound up by the deliquescent metal salt. That in turn is believed to enhance desiccation of the plant tissue and therefore the herbicidal efficacy of the compositions.

Examples of suitable hydrophobic liquids include, but are not limited to, organic solvents (e.g. xylene, toluene, C5-C12 alkanes), mineral oil (e.g. paraffin oil), plant oil (e.g. seed oil and terpenes), petroleum distillate (e.g. kerosene, mineral spirits, white spirits, and Stoddard solvent), animal oil, fatty acids, and combinations thereof.

In one embodiment, the herbicide composition comprises a plant oil. Examples of suitable plant oils that may be used include, but are not limited to, methylated seed oil, alkylated seed oil.

In one embodiment, the hydrophobic liquid comprises one or more terpenes.

Examples of terpenes include, pinene, nerol, citral, menthol, limonene, careen, cineol, camphene, dipentene and terpinolene.

Those skilled in the art will appreciate terpenes are typically derived or sourced from plant oils such as gum turpentine, pine oil, eucalyptus oil, conifer oil, tea tree oil and combinations thereof.

In one embodiment, the herbicide composition comprises one or more of gum turpentine, pine oil, eucalyptus oil, conifer oil, tea tree oil and combinations thereof.

In one embodiment, the herbicide composition comprises one or more terpenes derived or sourced from one or more of gum turpentine, pine oil, eucalyptus oil, conifer oil, tea tree oil and combinations thereof.

When used, a hydrophobic liquid will generally be present in the herbicide composition in an amount ranging from about 0.1 wt % to about 30 wt %.

In one embodiment, the herbicide compositions in accordance with the invention comprise about 15 wt % to about 30 wt % hydrophobic liquid, or about 3 wt % to about 15 wt %, or from about 0.1 wt % to about 1 wt %.

The present invention also provides a method of preparing a herbicide composition, the method comprising combining with water: hydrochloric acid, one or both of citric acid and a citrate salt, acetic acid, and at least two metal salts, wherein at least one of the metal salts is a transition metal salt and the at least two meal salts are combined with the water in an independent amount of at least 0.005 wt %.

It will be appreciated that reference herein to the at least two metal salts being combined with water in an “independent” amount of at least 0.005 wt % is intended to be in the context of the transition and non-transition metal salt content. In other words, the compositions may prepared using one or more transition metals salts with a combined mass of at least 0.005 wt % or one or more non-transition metals salts with a combined mass of at least 0.005 wt %. Where only one transition and non-transition metal salts are used, each salt will be combined with water in an amount of at least 0.005 wt %. The metal salts may of course be combined with the water individually or in the form of a mixture of metal salts.

In one embodiment, the method of preparing the herbicide composition further comprises combining with the water an ammonium salt.

According to the method of the invention, a given constituent components of the herbicide composition is combined with or introduced to the water. It will be appreciated “the water” may of course contain one of more other constituent components previous added to the water.

In a further embodiment, the method of preparing the herbicide further comprises combining with the water: phosphoric acid.

In yet a further embodiment, the method of preparing the herbicide composition further comprises combining with the water: sulphuric acid.

In still a further embodiment, the method of preparing the herbicide composition further comprises combining with the water: a surfactant.

In another embodiment, the method of preparing the herbicide composition further comprises combining with the water: a hydrophobic liquid.

In still a further embodiment, the method of preparing the herbicide composition further comprises combining with the water: an aqueous freezing point supressing agent.

Upon introducing water soluble formulation components of the herbicide composition to the water, those components will typically dissolve in the water.

The type and amount of constituent components used in preparing the herbicide composition include those herein described.

When preparing the herbicide composition one or both of citric acid and a citrate salt are combined with the water.

In one embodiment, the method of preparing a herbicide composition comprises only combining citric acid with the water.

Where only citric acid is combined with the water, it may nevertheless be possible to form a citrate salt from the citric acid in situ during preparation of the composition. For example, the method of preparing the herbicide composition may comprise a step of introducing sodium hypochlorite. Without wishing to be limited by theory, it is believed the introduction of sodium hypochlorite during preparation of the herbicide composition can convert at least some of the citric acid present into sodium citrate (i.e. a citrate salt).

If used during preparing the herbicide composition, the sodium hypochlorite will generally be added in an amount ranging from about 0.5 wt % to about 2.5 wt %, or from about 1 wt % to about 2 wt %, on the basis of using a 13 wt % sodium hypochlorite aqueous solution.

In one embodiment, the method of preparing the herbicide composition comprises introducing sodium hypochlorite in an amount to convert about 5 wt % to about 35 wt %, or about 5 wt % to about 30 wt %, or about 10 wt % to about 25 wt %, or about 15 wt % to about 25 wt % of the citric acid content present into a citrate salt.

In one embodiment, the method of preparing the herbicide composition comprises a first step which comprises combining with the water: hydrochloric acid, citric acid and one of the at least two metal salts; a second step which comprises combining with the solution formed in step 1: the remaining metal salts and sodium hypochlorite; and a third step which comprises combining with the solution formed in step 2: acetic acid.

In a further embodiment, the addition of sodium hypochlorite in step 2 of the method converts at least some of the citric acid to sodium citrate.

In one embodiment, the method of preparing the herbicide composition comprises in step 2 addition of an aqueous freezing point supressing agent.

In a further embodiment, the method of preparing the herbicide composition comprises a further step which comprises combining with the solution formed in step 3: an ammonium salt.

In yet a further embodiment, the method of preparing the herbicide composition comprises a further step which comprises combining with the solution formed in step 3 a water solution comprising an ammonium salt and citric acid.

In another embodiment, the method of preparing the herbicide composition comprises a further step of combining with the solution formed in step 3: a water solution comprising phosphoric acid and citric acid.

In yet a further embodiment, the method of preparing the herbicide composition comprises a further step of combining the solution formed in step 3: a water solution comprising an ammonium salt, citric acid and sulphuric acid.

In another embodiment, the method of preparing the herbicide composition comprises a further step of combining with the solution formed in step 3: a water solution comprising 15-30 wt % ammonium salt, 25-45 wt % citric acid and 5-20 wt % sulphuric acid. The remainder of the water solution will be made up of water, for example demineralised water.

In another embodiment, the method of preparing the herbicide composition comprises a further step of combining with the solution formed in step 3: a water solution comprising zinc chloride, surfactant and hydrophobic liquid.

In a further embodiment, the method of preparing the herbicide composition comprises a further step of combining with the solution formed in step 3: a water solution comprising zinc chloride, aqueous freezing point suppression agent, acetic acid, surfactant and hydrophobic liquid.

In another embodiment, the method of preparing the herbicide composition comprises a further step of combining with the solution formed in step 3: a water solution comprising 5-20 wt % zinc chloride, 10-40 wt % surfactant and 15-50 wt % hydrophobic liquid.

In a further embodiment, the method of preparing the herbicide composition comprises a further step of combining with the solution formed in step 3: a water solution comprising 5-15 wt % zinc chloride, 5-15 wt % aqueous freezing point suppression agent, 5-15 wt % acetic acid, 15-35 wt % surfactant and 20-40 wt % hydrophobic liquid.

Without wishing to be limited by theory, where sodium hypochlorite is used in preparing the herbicide composition in accordance with the invention it is believed the sodium hypochlorite reacts with one or more of the constituent components present in the composition. Accordingly, it is believed that sodium hypochlorite per se is not retained as a constituent component in the so formed composition. Rather, products formed from the reaction of sodium hypochlorite and one or more of the other constituent components of the composition are believed to be formed in situ. While it is believed that sodium hypochlorite reacts with citric acid to produce sodium citrate, the sodium hypochlorite may react with one or more other components to form a variety of products.

Accordingly, the present invention further provides a herbicide composition comprising: water, hydrochloric acid, acetic acid, one or both of citric acid and a citrate salt, and at least two metal salts, wherein at least one of the metal salts is a transition metal salt and the at least two meal salts are present in an amount of at least 0.005 wt %., the composition further comprising one or more products formed through reaction of sodium hypochlorite with one or more of the hydrochloric acid, the acetic acid, the citric acid and the at least two metal salts.

When preparing the herbicide composition in accordance with the invention it will often be desirable that the water soluble constituent components being used are maintained in solution. The method of preparing the herbicide composition may therefore comprise applying heat and/or agitation (e.g. stirring) to assist with dissolving the constituent components in the water. Heat and agitation may be applied by any conventional means. For example, heat may be applied to a vessel in which the components are introduced. Alternatively, the addition of sulphuric acid to the composition during manufacture can promote an exothermic event so as to heat the so formed solution and facilitate dissolving the constituent components.

In one embodiment, the method of preparing the herbicide composition comprises applying one or both of heat and agitation to the composition while it is being prepared. The composition may be heated to temperatures ranging from about 40° C. to about 70° C., or about 50° C. to about 65° C.

If desired, when preparing the herbicide composition in accordance with the invention the resulting composition, or intermediate compositions, may be filtered to remove any non-solubilised components. Filtration may be preformed using conventional techniques/equipment.

The herbicide compositions in accordance with the present invention may be conveniently provided in the form of a concentrate formulation that may be applied to a plant or locus in that form, or diluted with water prior to application to a plant or locus.

In one embodiment, a herbicide composition in accordance with the present invention comprises about 2 wt % to about 25 wt % water, about 0.032 wt % to about 1.6 wt % hydrochloric acid, about 2 wt % to about 20 wt % of one or both of citric acid and a citrate salt, about 30 wt % to about 90 wt % glacial acetic acid, and at least two metal salts, wherein at least one of the metal salts is a transition metal salt and the at least two metal salts are independently present in an amount ranging from about 2 wt % to about 10 wt %. That formulation may optionally comprise about 1 wt % to about 10 wt % ammonium salt, and/or about 1 wt % to about 10 wt % phosphoric acid, and/or about 0.1 wt % to about 0.3 wt % concentrated sulphuric acid, and/or about 6 wt % to about 10 wt % aqueous freezing point supressing agent, and/or about 10 wt % to about 20 wt % surfactant, and/or about 15 wt % to about 30 wt % hydrophobic liquid.

In another embodiment, a herbicide composition in accordance with the present invention comprises about 35 wt % to about 65 wt % water, about 0.096 wt % to about 0.64 wt % hydrochloric acid, about 0.6 wt % to about 7 wt % of one or both of citric acid and a citrate salt, about 10 wt % to about 30 wt % glacial acetic acid, and at least two metal salts, wherein at least one of the metal salts is a transition metal salt and the at least two metal salts are independently present in an amount ranging from about 0.6 wt % to about 4 wt %. That formulation may optionally comprise about 0.6 wt % to about 5 wt % ammonium salt, and/or about 0.6 wt % to about 5 wt % phosphoric acid, and/or about 0.05 wt % to about 0.1 wt % concentrated sulphuric acid, and/or about 3 wt % to about 6 wt % aqueous freezing point supressing agent, and/or about 2 wt % to about 10 wt % surfactant, and/or about 3 wt % to about 15 wt % hydrophobic liquid.

In another embodiment, a herbicide composition in accordance with the present invention comprises about 75 wt % to about 98 wt % water, about 0.0096 wt % to about 0.16 wt % hydrochloric acid, about 0.4 wt % to about 4 wt % of one or both of citric acid and a citrate salt, about 1.5 wt % to about 10 wt % glacial acetic acid, and at least two metal salts, wherein at least one of the metal salts is a transition metal salt and the at least two metal salts are independently present in an amount ranging from about 0.005 wt % to about 2 wt %. That formulation may optionally comprise about 0.4 wt % to about 2 wt % ammonium salt, and/or about 0.4 wt % to about 2 wt % phosphoric acid, and/or about 0.025 wt % to about 0.05 wt % concentrated sulphuric acid, and/or about 0.05 wt % to about 3 wt % aqueous freezing point supressing agent, and/or about 0.0001 wt % to about 2 wt % surfactant, and/or about 0.1 wt % to about 1 wt % hydrophobic liquid.

In one embodiment, a herbicide composition in accordance with the present invention comprises about 75 wt % to about 98 wt % water, about 0.0096 wt % to about 0.16 wt % hydrochloric acid, about 0.4 wt % to about 4 wt % of one or both of citric acid and a citrate salt, about 1.5 wt % to about 10 wt % glacial acetic acid, and at least two metal salts, wherein at least one of the metal salts is a transition metal salt, with each metal salt independently being present in an amount ranging from about 0.005 wt % to about 2 wt %. That formulation may optionally comprise about 0.4 wt % to about 2 wt % ammonium salt, and/or about 0.4 wt % to about 2 wt % phosphoric acid, and/or about 0.025 wt % to about 0.05 wt % concentrated sulphuric acid, and/or about 0.05 wt % to about 3 wt % aqueous freezing point supressing agent, and/or about 0.0001 wt % to about 2 wt % surfactant, and/or about 0.1 wt % to about 1 wt % hydrophobic liquid.

In a further embodiment, a herbicide composition in accordance with the present invention comprises about 2 wt % to about 25 wt % water, about 0.032 wt % to about 1.6 wt % hydrochloric acid, about 2 wt % to about 20 wt % of one or both of citric acid and a citrate salt, about 30 wt % to about 90 wt % glacial acetic acid, and at least two metal salts, wherein at least one of the metal salts is a transition metal salt, with each metal salt independently being present in an amount ranging from about 2 wt % to about 10 wt %. That formulation may optionally comprise about 1 wt % to about 10 wt % ammonium salt, and/or about 1 wt % to about 10 wt % phosphoric acid, and/or about 0.1 wt % to about 0.3 wt % concentrated sulphuric acid, and/or about 6 wt % to about 10 wt % aqueous freezing point supressing agent, and/or about 10 wt % to about 20 wt % surfactant, and/or about 15 wt % to about 30 wt % hydrophobic liquid.

In one embodiment, a herbicide composition in accordance with the present invention comprises about 35 wt % to about 65 wt % water, about 0.096 wt % to about 0.64 wt % hydrochloric acid, about 0.6 wt % to about 7 wt % of one or both of citric acid and a citrate salt, about 10 wt % to about 30 wt % glacial acetic acid, and at least two metal salts, wherein at least one of the metal salts is a transition metal salt, with each metal salt independently being present in an amount ranging from about 0.6 wt % to about 4 wt %. That formulation may optionally comprise about 0.6 wt % to about 5 wt % ammonium salt, and/or about 0.6 wt % to about 5 wt % phosphoric acid, and/or about 0.05 wt % to about 0.1 wt % concentrated sulphuric acid, and/or about 3 wt % to about 6 wt % aqueous freezing point supressing agent, and/or about 2 wt % to about 10 wt % surfactant, and/or about 3 wt % to about 15 wt % hydrophobic liquid.

To assist with maintaining constituent components of the herbicide composition in solution during manufacture it may be desirable to divide one or more constituent components across two or more of formulation solutions. For example, the amount of one or both of the citric acid and citrate salt components may be divided across two or more formulation solutions that are combined to form the herbicide composition.

In one embodiment, the method of preparing the herbicide composition comprises using a formulation solution (A) comprising water, one or both citric acid and a citrate salt and an ammonium salt. In that case, the water content of formulation solution (A) may range from about 20 wt % to about 45 wt %, the citric acid and/or citrate salt content may range from about 20 wt % to about 45 wt % and the ammonium salt content may range from about 15 wt % to about 45 wt %.

Such a formulation solution (A) may further comprises one or both of sulphuric acid and phosphoric acid. In that case, the sulphuric acid may be present in an amount ranging from about 5 wt % to about 20 wt % and the phosphoric acid may be present in an amount ranging from about 15 wt % to about 45 wt %.

Alternatively, the herbicide composition may be prepared using formulation solution (B) comprising water, one or both of citric acid and citrate salt and phosphoric acid.

Formulation solution (B) may further comprise sulphuric acid.

Formulation solution (B) may comprise water in an amount ranging from about 20 wt % to about 45 wt %, citric acid and/or a citrate salt in an amount ranging from about 20 wt % to about 45 wt %, phosphoric acid in an amount ranging from about 15 wt % to about 45 wt %, and optionally sulphuric acid in an amount ranging from about 5 wt % to about 20 wt %.

In one embodiment, the method of preparing the herbicide composition comprises (i) combining with water: hydrochloric acid, one or both citric acid and a citrate salt, acetic acid and at least two metal salts, wherein at least one of the metal salts is a transition metal salt to form a first solution, (ii) diluting the so formed first solution with water to form a second solution, and (iii) combining the so formed second solution with a third solution comprising water, one or both of citric acid and a citrate salt, one or both of an ammonium salt and phosphoric acid, and optionally sulphuric acid.

In a further embodiment, the method of preparing the herbicide composition comprises a first step which comprises combining with water: hydrochloric acid, citric acid and one of the at least two metal salts; a second step which comprises combining with the solution formed in step 1: the remaining metal salts and sodium hypochlorite; a third step which comprises combining with the solution formed in step 2: acetic acid, so as to form a first solution; a fourth step which comprises diluting the first solution with water to form a second solution; and a fifth step which comprises combining the second solution with a third solution which comprises water, one or both of citric acid and a citrate salt, one or both of an ammonium salt and phosphoric acid and optionally sulphuric acid.

In one embodiment, the method of preparing the herbicide composition comprises combining together:
(i) about 2 wt % to about 14 wt % of solution (I) which comprises water in an amount ranging from about 2 wt % to about 25 wt %, hydrochloric acid in an amount ranging from about 0.032 wt % to about 1.6 wt %, one or both of citric acid and citrate salt in an amount ranging from about 2 wt % to about 20 wt %, at least two metal salts, wherein at least one of the metal salts is a transition metal salt and the at least two metal salts are independently present in an amount ranging from about 2 wt % to about 10 wt %, and acetic acid in an amount ranging from about 30 wt % to about 90 wt %;
(ii) about 75 wt % to about 97.5 wt % water;
(iii) about 0.4 wt % to about 10 wt % of solution (II) which comprises about 20 wt % to about 45 wt % water, about 20 wt % to about 45 wt % of one or both of citric acid and a citrate salt, one or both of an ammonium salt and phosphoric acid, each being independently present in an amount ranging from about 15 wt % to about 45 wt %, and optionally sulphuric acid in an amount ranging from about 5 wt % to about 20 wt %;
(iv) about 0.1 wt % to about 1.5 wt % surfactant; and
(v) about 0.2 wt % to about 2 wt % hydrophobic liquid.

In another embodiment, the method of preparing the herbicide composition comprises combining together:
(i) about 2 wt % to about 14 wt % of solution (I) which comprises water in an amount ranging from about 2 wt % to about 25 wt %, hydrochloric acid in an amount ranging from about 0.032 wt % to about 1.6 wt %, one or both of citric acid and citrate salt in an amount ranging from about 2 wt % to about 20 wt %, at least two metal salts, wherein at least one of the metal salts is a transition metal salt and each metal salt is independently present in an amount ranging from about 2 wt % to about 10 wt %, and acetic acid in an amount ranging from about 30 wt % to about 90 wt %;
(ii) about 75 wt % to about 97.5 wt % water;
(iii) about 0.4 wt % to about 10 wt % of solution (II) which comprises about 20 wt % to about 45 wt % water, about 20 wt % to about 45 wt % of one or both of citric acid and a citrate salt, one or both of an ammonium salt and phosphoric acid, each being independently present in an amount ranging from about 15 wt % to about 45 wt %, and optionally sulphuric acid in an amount ranging from about 5 wt % to about 20 wt %;
(iv) about 0.1 wt % to about 1.5 wt % surfactant; and
(v) about 0.2 wt % to about 2 wt % hydrophobic liquid.

In one embodiment, solution (I) is combined with the water (ii) before it is combined with solution (II). The surfactant and the hydrophobic liquid can be combined at any time with the other components of the composition.

In one embodiment, the method according to the invention comprises (i) combining with water: hydrochloric acid, one or both citric acid and a citrate salt, acetic acid and the at least two metal salts to form a first solution, and (ii) combining the so formed first solution with a second solution comprising water, at least one of the at least two metal salts, acetic acid, surfactant and hydrophobic liquid. An aqueous freezing point supressing agent may be combined in one or both of the first and second solution.

The present invention further provides a herbicide composition produced according to the method described herein.

When manufacturing the herbicide composition it may be convenient to first prepare a precursor herbicide composition and add to that composition acetic acid to form the herbicide composition.

The present invention therefore provides a precursor herbicide composition, the composition comprising water, hydrochloric acid, one or both of citric acid and a citrate salt, and at least two metal salts, wherein at least one of the metal salts is a transition metal salt and the at least two meal salts are independently present in an amount of at least 0.005 wt %.

Apart from acetic acid, other components to be included in the herbicide composition may be added to the precursor herbicide composition. The other components of the precursor composition (expect acetic acid) are the same as herein described for the herbicide composition.

The present invention further provides a method of preparing a precursor herbicide composition, the method comprising combining with water: hydrochloric acid, one or both of citric acid and a citrate salt, and at least two metal salts, wherein at least one of the metal salts is a transition metal salt and the at least two meal salts are combined with the water in an independent amount of at least 0.005 wt %.

In one embodiment, the method of preparing a precursor herbicide composition includes a first step comprising combining with water: hydrochloric acid, citric acid and one of the at least two metal salts; and a second step comprising combining with the solution formed in step 1: the remaining metal salt(s) and sodium hypochlorite.

The present invention further provides a method of preparing a herbicide composition, the method comprising combining the precursor herbicide composition according to the invention with acetic acid.

The present invention further provides a method of killing a plant or retarding its growth, the method comprising contacting the plant with a herbicide composition according to the present invention.

The present invention further provides controlling plant growth at a locus, the method comprising applying to the locus a herbicide composition according to the present invention.

As used herein, the expression “controlling plant growth at a locus” is intended to mean that plant growth is retarded, inhibited or prevented at the locus. The term “locus” in intended to mean any location where plant growth may occur. For example, the locus may be a region of soil in which a plant may grow or a surface upon which a plant may grow.

Contacting the plant with or applying to the locus a herbicide composition according to the invention may be achieved by conventional means in the application of herbicide compositions. For example, the herbicide composition may be rubbed or poured directly on to the plant or the locus. Alternatively, the herbicide composition may be sprayed onto the plant or the locus.

The present invention also provides for the use of a herbicide composition according to the invention to kill a plant or retard its growth. The present invention further provides for use of a herbicide composition according to the invention to control growth of a plant at a locus.

Use of a herbicide composition according to the invention may be performed as herein described and as is well known to those skilled in the art.

The present invention will hereinafter be described with reference to non-limiting examples.

### EXAMPLES

### Example 1: Herbicide Composition 1

Based on the formulation shown in Table 1, a solution of Hydrochloric Acid in water was prepared. Citric acid and magnesium chloride was added. The solution was warmed to 65° C. and agitated. Heating was switched off and copper nitrate (copper nitrate trihydrate dissolved in water, 50 wt %) solution added. Then sodium chloride was added under stirring. The acetic acid was then added and the solution stirred. Following the addition of acetic acid, the composition was cooled to room temperature and filtered through a nylon filter. The resulting solution was sealed and stored in an airtight container.

TABLE 1
Herbicide Composition 1.

| | % By weight |
|---|---|
| Water | 28.6 |
| Hydrochloric Acid* | 2.7 |
| Citric Acid (anhydrous) | 4.4 |
| Magnesium Chloride Hexahydrate | 5.7 |
| Copper Nitrate Solution | 3.3 |
| Sodium Chloride | 1.3 |
| Acetic Acid Glacial | 54.0 |

*approximately 320 g/L

### Example 2: Herbicide Composition 2

Based on the formulation shown in Table 2, a solution of Hydrochloric Acid in water was prepared. Citric acid and magnesium chloride was added. The solution was warmed to 65° C. and agitated. Heating was switched off and copper sulphate solution (copper sulphate pentahydrate dissolved in water, 50 wt %) added. Then sodium chloride was added under stirring. The acetic acid was then added and the solution stirred. Following the addition of acetic acid, the composition was cooled to room temperature and filtered through a nylon filter. The resulting solution was sealed and stored in an airtight container.

TABLE 2
Herbicide Composition 2.

| | % By weight |
|---|---|
| Water | 12.5 |
| Hydrochloric Acid* | 3.2 |
| Citric Acid (anhydrous) | 12.5 |
| Magnesium Chloride Hexahydrate | 3.0 |
| Copper Sulphate Pentahydrate Solution | 3.1 |
| Sodium Chloride | 1.9 |
| Acetic Acid Glacial | 63.8 |

*approximately 320 g/L

In one embodiment, the method of preparing the herbicide composition comprises combining together:

### Example 3: Herbicide Composition 3

Based on the formulation shown in Table 3, a solution of Hydrochloric Acid in water was prepared. Citric acid and magnesium chloride (40%) was added. The solution was warmed to 65° C. and agitated. The solution was near or at the saturation point. Heating was switched off and copper chloride solution added. Then the reminder of magnesium chloride (60%) and sodium hypochlorite solution was added under stirring. The acetic acid was then added and the solution is stirred. Following the addition of acetic acid, the composition was cooled to room temperature and filtered through a nylon filter. The resulting solution was sealed and stored in an airtight container.

TABLE 3
Herbicide Composition 3.

| | % By weight |
|---|---|
| Water | 3.4 |
| Hydrochloric Acid* | 2.4 |
| Citric Acid (anhydrous) | 4.0 |
| Magnesium Chloride Hexahydrate | 5.7 |
| Copper Chloride Solution | 3.3 |
| Sodium Hypochlorite** | 1.3 |
| Acetic Acid Glacial | 79.9 |

*approximately 320 g/L
**approximately 13%

### Example 4: Herbicide Composition 4

Based on the formulation shown in Table 4, a solution of Hydrochloric Acid in water was prepared. Citric acid and magnesium chloride (40%) was added. The solution was warmed to 65° C. and agitated. This solution was near or at the saturation point. Heating was switched off and copper chloride solution added. Then the reminder of magnesium chloride (60%) and sodium hypochlorite was added under stirring. The acetic acid was then added and the solution stirred. Then the ammonium sulphate was added. Following the addition of ammonium sulphate, the composition was cooled to room temperature and filtered through a nylon filter. The resulting solution was sealed and stored in an airtight container.

TABLE 4
Herbicide Composition 4.

| | % By weight |
|---|---|
| Water | 13.7 |
| Hydrochloric Acid* | 1.6 |
| Citric Acid (anhydrous) | 13.3 |
| Magnesium Chloride Hexahydrate | 3.8 |
| Copper Chloride Solution | 2.2 |
| Sodium Hypochlorite | 0.9 |
| Ammonium Sulphate | 10.6 |
| Acetic Acid Glacial | 53.8 |

*approximately 320 g/L

### Example 5: Herbicide Composition 5 and 6

A two component herbicide composition was prepared by combing 5a and component 5b (or 5a and component 5c) at a 2:1 ratio. Based on the formulation in Table 5, 5a was prepared by preparing a solution of hydrochloric acid in water. Citric acid and magnesium chloride (40%) was added. The solution was warmed to 65° C. and agitated. This solution was near or at the saturation point. Heating was switched off and copper chloride solution added. Then the reminder of magnesium chloride (60%) and sodium hypochlorite was added under stirring. The acetic acid was then added and the solution was stirred. Following the addition of acetic acid, the composition was cooled to room temperature and filtered through a nylon filter. The resulting solution was sealed and stored in an airtight container.

TABLE 5
Herbicide Composition 5 a.

| | % By weight |
|---|---|
| Water | 3.4 |
| Hydrochloric Acid* | 2.4 |
| Citric Acid (anhydrous) | 4.0 |
| Magnesium Chloride Hexahydrate | 5.7 |
| Copper Chloride Solution | 3.3 |
| Sodium Hypochlorite** | 1.3 |
| Acetic Acid Glacial | 79.9 |

*approximately 320 g/L
**approximately 13%

Based on the formulation in Table 6, component 5b was prepared by preparing a solution of citric acid and ammonium sulphate in water. The solution was warmed to 65° C. and agitated. This solution was near or at the saturation point. Heating was switched off and the composition was cooled to room temperature and filtered through a nylon filter. The resulting solution was sealed and stored in an airtight container.

TABLE 6
Herbicide Composition Component 5 b.

| | % By weight |
|---|---|
| Water | 35.0 |
| Citric Acid (anhydrous) | 32.5 |
| Ammonium Sulphate | 32.5 |

Based on the formulation in Table 7, component 5c was prepared by preparing a solution of sulphuric acid in water. Citric acid and ammonium sulphate was added under stirring. The solution was warmed to 65° C. and agitated. This solution may be near or at the saturation point. Heating was switched off and the composition was cooled to room temperature and filtered through a nylon filter. The resulting solution was sealed and stored in an airtight container.

TABLE 7
Herbicide Composition Component 5c.

| | % By weight |
|---|---|
| Water | 28.2 |
| Sulphuric Acid* | 11.3 |
| Citric Acid (anhydrous) | 35.2 |
| Ammonium Sulphate | 25.3 |

*approximately 98%

Herbicide composition 5 was prepared by combining 5a and component 5b at a 2:1 ratio.

Herbicide composition 6 was prepared by combining 5a and component 5c at a 2:1 ratio.

### Example 6: Herbicide Composition 7

Based on the formulation shown in Table 8, a solution of Hydrochloric Acid in water was prepared. Citric acid and magnesium chloride (40%) was added. The solution was warmed to 65° C. and agitated. This solution was near or at the saturation point. Heating was switched off and copper chloride solution added. Then zinc chloride, the reminder of magnesium chloride (60%) and sodium hypochlorite was added under stirring. The acetic acid was then added and the solution stirred. The composition was cooled to room temperature and filtered through a nylon filter. The resulting solution was sealed and stored in an airtight container to provide a concentrate formulation.

The concentrate formulation was then diluted 1:15 with water and to this diluted solution was added 0.2 wt. % of non-ionic wetting agent and 0.4 wt. % of hydrophobic liquid (non-polar oil). The resulting solution was shaken to help emulsify the oil phase.

TABLE 8
Herbicide Composition 7.

| | % By weight |
|---|---|
| Water | 3.0 |
| Hydrochloric Acid* | 2.1 |
| Citric Acid (anhydrous) | 3.5 |
| Magnesium Chloride Hexahydrate | 5.0 |
| Copper Chloride Solution | 2.9 |
| Sodium Hypochlorite | 1.1 |
| Zinc chloride | 13.0 |
| Acetic Acid Glacial | 69.5 |

*approximately 320 g/L

### Example 7: Herbicide Composition 8

A two component herbicide composition was prepared by combing 8a and component 8b at a 2:1 ratio. Based on the formulation in Table 9, 8a was prepared by preparing a solution of hydrochloric acid in water. Copper chloride solution and Citric acid was added. The solution was warmed to 50° C. and agitated. This solution was near or at the saturation point. Heating was switched off, solution cooled to 30° C. and sodium hypochlorite was added under stirring. Zinc chloride was added and the temperature raised to 70° C. The solution was cooled. Isopropyl alcohol and acetic acid was added. The resulting solution was stirred and then filtered through a nylon filter. The product was sealed and stored in an airtight container.

TABLE 9
Herbicide Composition 8a.

| | % By weight |
|---|---|
| Water | 2.0 |
| Hydrochloric Acid* | 3.8 |
| Citric Acid (anhydrous) | 4.4 |
| Zinc Chloride Dihydrate | 10.8 |
| Copper Chloride Solution | 3.9 |
| Sodium Hypochlorite** | 0.3 |
| Isopropyl alcohol | 0.5 |
| Acetic Acid Glacial | 74.3 |

*approximately 320 g/L
**approximately 13%

Based on the formulation in Table 10, component 8b was prepared. Zinc chloride was added to the water and the temperature raised to 70° C. The solution was stirred and cooled to 50° C. before adding Isopropyl alcohol and Acetic acid. Then Alkyl Polyglucoside, Ethoxylated C9-11 alcohols and Pine Oil was added under stirring. The solution was stirred for another 30 minutes and then filtered through a nylon filter. The resulting solution was sealed and stored in an airtight container.

TABLE 10
Herbicide Composition Component 8b.

| | % By weight |
|---|---|
| Water | 3.9% |
| Zinc Chloride | 11.8% |
| Isopropyl alcohol | 7.0% |
| Acetic acid Glacial | 9.9% |
| Alkyl Polyglucoside | 3.2% |
| Ethoxylated C9-11 alcohols | 29.2% |
| Pine Oil | 35.0% |

Herbicide composition 8 was prepared by combining 8a and component 8b at a 2:1 ratio.

### Example 8: Herbicide Composition 9

A two component herbicide composition was prepared by combing 9a and component 9b at a 3:1 ratio. Based on the formulation in Table 11, 9a was prepared by preparing a solution of hydrochloric acid in water. Copper chloride solution and Citric acid was added. The solution was warmed to 50° C. and agitated. This solution was near or at the saturation point. Heating was switched off, solution cooled to 30° C. and sodium hypochlorite was added under stirring. Zinc chloride was added and the temperature raised to 70° C. The solution was cooled. Isopropyl alcohol and acetic acid was added. The resulting solution was stirred and then filtered through a nylon filter. The product was sealed and stored in an airtight container.

TABLE 11
Herbicide Composition 9a.

| | % By weight |
|---|---|
| Water | 2.0 |
| Hydrochloric Acid* | 3.8 |
| Citric Acid (anhydrous) | 4.4 |
| Zinc Chloride Dihydrate | 15.8 |
| Copper Chloride Solution | 3.9 |
| Sodium Hypochlorite** | 0.3 |
| Isopropyl alcohol | 0.5 |
| Acetic Acid Glacial | 69.3 |

*approximately 320 g/L
**approximately 13%

Based on the formulation in Table 12, component 9b was prepared. Zinc chloride was added to the water and the temperature raised to 70° C. The solution was stirred and cooled to 50° C. before adding Isopropyl alcohol and Acetic acid. Then Ethoxylated C9-11 alcohols, Solvent 150 and Pure Gum Turpentine was added under stirring. The solution was stirred for another 30 minutes and then filtered through a nylon filter. The resulting solution was sealed and stored in an airtight container.

TABLE 12
Herbicide Composition Component 9b.

| | % By weight |
|---|---|
| Water | 3.9% |
| Zinc Chloride | 11.8% |
| Isopropyl alcohol | 7.0% |
| Acetic acid Glacial | 14.9% |
| Ethoxylated C9-11 alcohols | 28.4% |
| Solvent 150 | 17.5% |
| Pure Gum Turpentine | 17.5% |

Herbicide composition 9 was prepared by combining 9a and component 9b at a 3:1 ratio.

### Example 9: Application of the Herbicide Compositions

### Example 9a: Field Trial to Evaluate Efficacy of Herbicide Composition 1 for the Control of Weeds in Fallow

A field trial was conducted in Queensland to evaluate the efficacy of Composition 1 for the control of weeds in fallow. Treatments included Composition 1 at 200 g Composition 1 per L of water at spray application volumes of 500, 750 or 1000 L/ha and dilute spray to the point of run-off. A proprietary, non-ionic Wetting Agent was added to the spray mixture at an addition rate of 0.2% of spray mixture. Treatments were compared with Basta 200 SL at 0.5 L/100 L in a spray application volume of 1000 L/ha water or a dilute spray to the point of run-off and an untreated control.

Broadleaf weed species included burr medic (Medicago polymorpha) [MEDPO], marshmallow (Malva parviflora) [MALPO] and sowthistle (Sonchus oleraceus) [SONOL]. Grass weed species included stinkgrass (Eragrostis cilianensis) [ERACN] only.

One foliar application was applied to weeds at the BBCH 13-15 growth stage. Weed density was assessed prior to treatment application at 0 days after application (ODAA) and 27DAA. Weed brownout was assessed at 7DAA, 17DAA and 27DAA.

Prior to application there was a mean density of 28.3 MEDPO, 7.5 SONOL, 1.8 MALPA and 10.5 ERACN per 12 m² in the untreated control.

Composition 1 at 20 L/100 L applied in a spray volume of 500, 750 or 1000 L/ha or as a dilute spray to run-off provided significant brownout of MEDPO and MALPA and significant brownout and density reduction of SONOL and ERACN compared to the untreated control in fallow with the highest rate and the dilute spray to run-off application generally superior to the lower rates.

Composition 1 was generally less efficacious than Basta 200 SL for the control of MEDPO, MALPA, SONOL and ERACN. However, when applied as a dilute spray to the point of run-off for the control of SONOL, Composition 1 was equivalent to Basta 200 SL.

### Example 9b: Field Trial to Evaluate Efficacy of Herbicide Composition 3 for the Control of Weeds in Fallow

A field trial was conducted in New South Wales to evaluate Composition 3 for control of seedling canola (Brassica napus), shepherd's purse (Capsella bursa-pastoris), annual ryegrass (Lolium rigidum) and wild radish (Raphanus raphanistrum) in fallow. Composition 3 was applied at 625 g Composition 3 per L of spray mixture by boom spray in spray volumes of 500, 750 and 1000 L/ha, to the point of run-off with a full cone nozzle in a spray volume of 1500 L/ha. A proprietary, non-ionic Wetting Agent was added to the spray mixture at an addition rate of 0.2% of spray mixture. Composition 3 was compared to Basta 200 SL applied at 1 kg/ha by boom spray in a total spray volume of 1000 L/ha or at 2 kg/ha to the point of run-off in a spray volume of 1500 L/ha and an untreated control. All herbicide treatments were applied with a coarse spray quality to actively growing weeds. At the time of application canola was at the 1-2 leaf stage, shepherd's purse and wild radish were 6 leaf stage and annual ryegrass was 2-3 leaf stage.

A pre-spray weed count by species was conducted at 0 days after application (ODAA) with surviving weed numbers by species assessed at 27DAA. Weed brownout by species was assessed at 7, 14 and 27DAA.

Composition 3 was very effective for the control of broadleaf weeds when applied to the point of run-off, with complete control of canola compared to the untreated control, 97% control of shepherd's purse and 94% control of wild radish. It was less effective for the control of annual ryegrass, despite excellent brownout at 14DAA, recording 70% control compared to the untreated control at 27DAA.

Composition 3 demonstrated a strong rate response for weed brownout. When applied to the point of run-off, Composition 3 provided equivalent control of annual ryegrass to Basta and more effective control against broadleaf weeds. Composition 3 was also equivalent to Basta for the control of canola and wild radish but slightly less effective against shepherd's purse and annual ryegrass.

### Example 9c: Field Trial to Evaluate Efficacy of Herbicide Composition 6 for the Control of Weeds in Fallow

A field trial was conducted in Victoria to evaluate Composition 6 (containing 5a and component 5c) for the control of volunteer wheat (Triticum aestivum), annual ryegrass (Lolium rigidum) and wild radish (Raphanus raphanistrum) in fallow. Treatments included Composition 6 applied at 32 ml/L of water, Composition 6 applied at 16 ml/L of water, in a spray volume of either 500, 750, 1000 or to the point of run-off, which was 1250 L/ha. A proprietary, non-ionic Wetting Agent was added to the spray mixture at an addition rate of 0.2% of spray mixture. Treatments with Composition 6 were compared with Basta 200 SL applied at 5 mL/L in a spray volume of either 1000 or 1250 L/ha and an untreated control (UTC). Treatments were applied as a foliar spray to actively growing weeds at the BBCH 14-16 growth stage using AIXR 110-02 flat fan nozzles in a spray volume ranging from 500-1250 L/ha. Multiple spray passes were made over each plot to obtain the target spray volume of each treatment.

Weed brownout was assessed at 7 days after application (7DAA), 14DAA and 28DAA, with weed density also assessed at 28DAA.

All rates of Composition 6 provided significant control of volunteer wheat, annual ryegrass and wild radish compared to the UTC at all assessment timings. By 28DAA, the highest water rate of LocalSafe 540 SL achieved 93% brownout of volunteer wheat, 90% brownout of annual ryegrass and 89% brownout of wild radish.

A significant rate response was seen for Composition 6 applied at water rates of 500 to 1250 L/ha, with control of all weeds increasing with increasing spray volumes, resulting in application to the point of run-off achieving optimum control.

Basta 200 SL provided comparable control of volunteer wheat, annual ryegrass and wild radish compared to the corresponding spray volumes of Composition 6.

### Example 9d: Field Trial to Evaluate Efficacy of Herbicide Composition 7 for the Control of Weeds in Fallow

A field trial was conducted in Spain to evaluate Composition 7 for the control of docks (rumex spp), fat hen (Chenopodium album), plantains (plantago spp.) and dandelion (taraxacum spp), in fallow. Treatments included Composition 7 applied at 67 ml/L of water, in a spray volume of approx 1000 L/ha. A proprietary, non-ionic Wetting Agent was added to the spray mixture at an addition rate of 0.2% of spray mixture. A proprietary, hydrophobic liquid was added to the spray mixture at an addition rate of 0.4% of spray mixture. Treatments with Composition 7 were compared with Glyphosate 360 g/L applied at 30 mL/L in a spray volume of either approx. 1000 L/ha and an untreated control (UTC). Treatments were applied as a foliar spray to actively growing weeds at the BBCH 14-16 growth stage using round nozzles in a spray volume of 1000 L/ha.

Weed brownout was assessed at 1 days after application (1DAA), (7DAA), 14DAA and 28DAA, with weed density also assessed at 28DAA.

All rates of Composition 7 provided significant control of all weeds compared to the UTC at all assessment timings. By 28DAA, the Composition 7 achieved 90% brownout of all weeds.

Glyphosate 360 g/L provided comparable control of weeds in fallow compared to the corresponding spray of Composition 7.

### Example 9e: Field Trial to Evaluate Efficacy of Herbicide Composition 8 for the Control of Weeds in Vineyards

A field trial was conducted in Victoria to evaluate Composition 8 for the control of ryegrass (lolium), paspalum (Paspalum dilatatum), milk thistle (Silybum marianum), plantains (plantago spp.) and flaxleaf fleabane (Conyza banariensis), in vineyards. Treatments included Composition 8 applied at 67 ml/L of water, in a spray volume of approx 750 L/ha. Treatments with Composition 8 were compared with Slasher P(525 g/L pelargonic acid) applied at 67 mL/L in a spray volume of approx. 750 L/ha and an untreated control (UTC). Treatments were applied as a foliar spray to actively growing weeds using round nozzles in a spray volume of 750 L/ha.

Weed brownout was assessed at 1 days after application (1DAA), (7DAA), 14DAA and 28DAA, with weed density also assessed at 28DAA.

Composition 8 provided significant control of all weeds compared to the UTC at all assessment timings. By 28DAA, the Composition 8 achieved 90% brownout of all weeds.

Slasher provided less control of weeds in vineyard compared to the corresponding spray of Composition 8.

### Example 9f: Field Trial to Evaluate Efficacy of Herbicide Composition 9 for the Control of Weeds in Fallow

A field trial was conducted in Victoria to evaluate Composition 9 for the control of common purslane (Portulaca oleracea), docks (rumex spp), felt grass (ehrharta), plantains (plantago spp.) and dandelion (taraxacum spp), in fallow. Treatments included Composition 9 applied at 48 ml/L of water, in a spray volume of approx 1000 L/ha. Treatments with Composition 9 were compared with Basta applied at 20 mL/L in a spray volume of approx. 1000 L/ha and an untreated control (UTC). Treatments were applied as a foliar spray to actively growing weeds at the BBCH 14-16 growth stage using round nozzles in a spray volume of 1000 L/ha.

Weed brownout was assessed at 1 days after application (1DAA), (7DAA), 14DAA and 28DAA, with weed density also assessed at 28DAA.

Composition 9 provided significant control of all weeds compared to the UTC at all assessment timings. By 28DAA, the Composition 8 achieved 85% brownout of all weeds.

Basta provided comparable control of weeds in fallow compared to the corresponding spray of Composition 9.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates

1. A herbicide composition comprising water, hydrochloric acid, acetic acid, one or both of citric acid and a citrate salt, and at least two metal salts, wherein at least one of the metal salts is a transition metal salt and the at least two metal salts are independently present in an amount of at least 0.005 wt %.

2. The herbicide composition according to claim 1 further comprising an ammonium salt.

3. The herbicide composition according to claim 1 further comprising sulphuric acid.

4. The herbicide composition according to claim 1 further comprising a hydrophobic liquid.

5. The herbicide composition according to claim 1 further comprising one or more of gum turpentine, pine oil, eucalyptus oil, conifer oil, and tea tree oil.

6. The herbicide composition according to claim 1 further comprising an aqueous freezing point supressing agent.

7. The herbicide composition according to claim 1 further comprising a surfactant.

8. The herbicide composition according to claim 1, wherein the at least two metal salts comprise a copper salt and a zinc salt.

9. The herbicide composition according to claim 1 comprising about 2 wt % to about 35 wt % water, about 3 wt % to about 6 wt % hydrochloric acid, about 2 wt % to about 20 wt % of one or both of citric acid and a citrate salt, about 30 wt % to about 90 wt % acetic acid, wherein the least two metal salts are independently present in an amount ranging from about 2 wt % to about 60 wt %.

10. The herbicide composition according to claim 1 comprising about 75 wt % to about 98 wt % water, about 0.01 wt % to about 0.16 wt % hydrochloric acid, about 0.1 wt % to about 2 wt % of one or both of citric acid and a citrate salt, about 1.5 wt % to about 10 wt % acetic acid, wherein the least two metal salts are independently present in an amount ranging from about 0.01 wt % to about 2 wt %, and about 0.4 wt % to about 2 wt % ammonium salt.

11. A method of preparing a herbicide composition, the method comprising combining with water: hydrochloric acid, one or both of citric acid and a citrate salt, acetic acid, and at least two metal salts, wherein at least one of the metal salts is a transition metal salt and the at least two metal salt are combined with the water in an independent amount of at least 0.005 wt %.

12. The method according to claim 11 which further comprises combining with the water: an ammonium salt.

13. The method according to claim 11 which further comprises combining with the water: a hydrophobic liquid.

14. The method according to claim 11 which further comprises combining with the water: sulfuric acid.

15. The method according to claim 11 which further comprises combining with the water: one or more of gum turpentine, pine oil, eucalyptus oil, conifer oil, and tea tree oil.

16. The method according to claim 11 which further comprises combining with the water: an aqueous freezing point supressing agent.

17. The method according to claim 11 which further comprises combining with the water: a surfactant.

18. The method according to claim 11 comprising a first step which comprises combining with the water the: hydrochloric acid, citric acid and one of the at least two metal salts; a second step which comprises combining with the solution formed in step 1 the: remaining metal salt(s) and sodium hypochlorite; and a third step which comprises combining with the solution formed in step 2 the: acetic acid.

19. The method according to claim 18 which comprises a further step of combining with the solution formed in step 3 a water solution comprising an ammonium salt and citric acid.

20. The method according to claim 11 which comprises (i) combining with water the: hydrochloric acid, one or both citric acid and a citrate salt, acetic acid and the at least two metal salts to form a first solution, and (ii) combining the so formed first solution with a second solution comprising water, the at least one of the at least two metal salts, the acetic acid, surfactant and hydrophobic liquid.

21. The method according to claim 20, wherein an aqueous freezing point supressing agent is combined in the first or second solution.

22. The method according to claim 20, wherein the hydrophobic liquid is selected from one or more of gum turpentine, pine oil, eucalyptus oil, conifer oil, and tea tree oil.

23. A method of killing a plant or retarding its growth, the method comprising contacting the plant with a herbicide composition according to claim 1.

24. A method of controlling growth of a plant at a locus, the method comprising applying to the locus a herbicide composition according to claim 1.

25. A herbicide composition comprising water, hydrochloric acid, acetic acid, one or both of citric acid and a citrate salt, and at least two metal salts, wherein at least one of the metal salts is a transition metal salt and the at least two metal salts are independently present in an amount of at least 0.005 wt %, and one or more products formed through reaction of sodium hypochlorite with one or more of the hydrochloric acid, the acetic acid, the citric acid and the at least two metal salts.

26. A precursor herbicide composition, the composition comprising water, hydrochloric acid, one or both of citric acid and a citrate salt, and at least two metal salts, wherein at least one of the metal salts is a transition metal salt and the at least two metals salts are independently present in an amount of at least 0.005 wt %.
